(19) United States
(12) Patent Application Publication
(10) Pub. No.: US 2020/0354069 A1
(43) Pub. Date: Nov. 12, 2020

(54) DEVICES AND SYSTEMS UTILIZING A SINGLE CHIP FOR CONTROL OF DEVICE MOVEMENT

(71) Applicant: SZ DJI TECHNOLOGY CO., LTD., Shenzhen (CN)

(72) Inventors: Yupeng ZHAO, Shenzhen (CN); Bin YI, Shenzhen (CN); Shengbao YIN, Shenzhen (CN); Lijian LIU, Shenzhen (CN); Hua LU, Shenzhen (CN)

(21) Appl. No.: 16/937,180

(22) Filed: Jul. 23, 2020

Related U.S. Application Data
(63) Continuation of application No. PCT/CN2018/073865, filed on Jan. 23, 2018.

(51) Int. Cl. B64D 27/24; B64C 39/02; B64D 47/08

(52) U.S. Cl. CPC B64D 27/24; B64C 39/024; B64D 2221/00; B64C 2201/123; B64D 47/08

(57) ABSTRACT

An integrated controller for controlling a movable object includes a connector, a movement control subsystem communicatively coupled to the connector and configured to control movement of the movable object, a vision subsystem communicatively coupled to the connector and configured to provide visualization of an operating environment surrounding the movable object, and a platform subsystem communicatively coupled to the connector and configured to provide timing and power management to the movement control subsystem and the vision subsystem.

### CROSS-REFERENCE TO RELATED APPLICATION

This application is a continuation of International Application No. PCT/CN2018/073865, filed Jan. 23, 2018, the entire content of which is incorporated herein by reference.

### TECHNICAL FIELD

The present disclosure relates generally to device movement control and, more particularly, to devices and systems for movement control of flying devices.

### BACKGROUND

Unmanned aerial vehicles (“UAV”), sometimes referred to as “drones,” include pilotless aircraft of various sizes and configurations that can be remotely operated by a user and/or programmed for automated flight. UAVs can be used for many purposes and are often used in a wide variety of personal, commercial, and tactical applications. In many applications, UAVs can also be equipped with secondary devices to perform various tasks. For instance, UAVs equipped with imaging equipment, such as cameras, video cameras, etc., can capture images or video footage that is difficult, impractical, or simply impossible to capture otherwise. UAVs equipped with imaging devices find particular use in the surveillance, national defense, and professional videography industries, among others, and are also popular with hobbyists and for recreational purposes.

Control systems for UAVs are often implemented using multiple microcontrollers or chips. For example, an UAV may include a flight control microcontroller configured to control flight operations of the UAV. The flight control microcontroller may be interconnected with a vision system implemented on a separate chip. The vision system may be configured to detect objects surrounding the UAV. The flight control microcontroller may receive information from the vision system and utilize the information to track a moving object or avoid an obstacle. The flight control microcontroller may also be interconnected with microcontrollers/chips utilized to control other devices, including imaging devices and/or gimbals that support the imaging devices. As the number of microcontrollers/chips increases, so do the size, cost, and complexity associated with implementing interconnections between them. As a result, control systems for UAVs become larger, more expensive, and more complex.

### SUMMARY

In one aspect, the present disclosure relates to an integrated controller for controlling a movable object. The integrated controller may include a connector and a movement control subsystem block communicatively coupled to the connector and configured to control movement of the movable object. The integrated controller may also include a vision subsystem block communicatively coupled to the connector and configured to provide visualization of an operating environment surrounding the movable object. The integrated controller may further include a platform subsystem block communicatively coupled to the connector and configured to provide timing and power management to the movement control subsystem block and the vision subsystem block.

In another aspect, the present disclosure relates to a moveable object. The moveable object may include one or more propulsion devices and an integrated controller in communication with the one or more propulsion devices and configured to control the moveable object. The integrated controller may include a connector and a movement control subsystem block communicatively coupled to the connector and configured to control movement of the movable object. The integrated controller may also include a vision subsystem block communicatively coupled to the connector and configured to provide visualization of an operating environment surrounding the movable object. The integrated controller may further include a platform subsystem block communicatively coupled to the connector and configured to provide timing and power management to the movement control subsystem block and the vision subsystem block.

In yet another aspect, the present disclosure relates to an integrated controller for controlling a movable object. The integrated controller may include a connector and a movement control subsystem block communicatively coupled to the connector and configured to control movement of the movable object. The integrated controller may also include a gimbal control subsystem block communicatively coupled to the connector and configured to control operation of a gimbal positioned on the movable object. The integrated controller may further include an imaging subsystem block communicatively coupled to the connector and configured to control operation of an imaging device mounted on the gimbal. The integrated controller may further include a vision subsystem block communicatively coupled to the connector and configured to provide visualization of an operating environment surrounding the movable object at least partially based on data obtained by the imaging device. Furthermore, the integrated controller may include a platform subsystem block communicatively coupled to the connector and configured to provide timing and power management to the movement control subsystem block, the gimbal control subsystem block, the imaging subsystem block, and the vision subsystem block.

It is to be understood that both the foregoing general description and the following detailed description are exemplary and explanatory only and are not restrictive of the invention, as claimed.

### BRIEF DESCRIPTION OF THE DRAWINGS

FIG. 1 shows a block diagram depicting functional relationships between components of an exemplary control system of a movable object (e.g., a UAV);

FIG. 2 shows an illustration depicting an exemplary visualization process configured in accordance with embodiments of the present disclosure;

FIG. 3 shows a control system configured in accordance with embodiments of the present disclosure;

FIG. 4 shows a movable object configured in accordance with embodiments of the present disclosure;

FIG. 5 shows an illustration depicting bandwidth management configured in accordance with embodiments of the present disclosure; and

FIG. 6 shows a flow diagram of an exemplary power management process configured in accordance with embodiments of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings. Accordingly, the following detailed description is not limited to the disclosed embodiments and examples. Instead, the proper scope is defined by the appended claims.

Unmanned aerial vehicles (UAVs) are recognized in many industries and in many situations as useful tools for relieving personnel of the responsibility for directly performing certain tasks. For instance, UAVs have been used to deliver cargo, conduct surveillance, and collect various types of imaging and sensory data (e.g., photo, video, ultrasonic, infrared, etc.) in professional and recreational settings, providing great flexibility and enhancement of human capabilities.

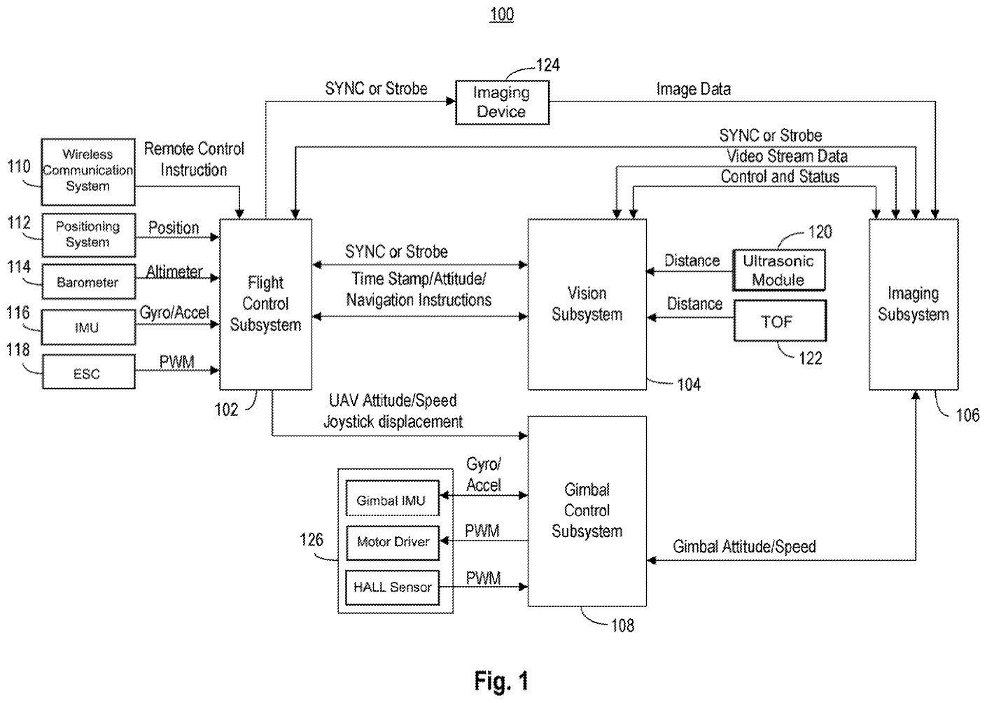

Because they may be “unmanned,” that is, operated without onboard personnel, control systems for UAVs often require additional components such as camera subsystems, vision subsystems, and the like, to help detect and/or visualize their surroundings. In this disclosure, a “subsystem” is also referred to as a “subsystem block” or a “block.” FIG. 1 shows the functional relationship between various components in an exemplary control system 100 for a UAV. As shown in FIG. 1, control system 100 may include a flight control subsystem 102, a vision subsystem 104, an imaging subsystem 106, and a gimbal control subsystem 108.

Flight control subsystem 102 may be configured to communicate with various devices onboard the UAV. For instance, flight control subsystem 102 may communicate with a wireless communication system 110 to receive remote control instructions from an operator. Flight control subsystem 102 may also communicate with a positioning system (e.g., a global navigation satellite system, or GNSS) 112 to receive data indicating the location of the UAV. Flight control subsystem 102 may communicate with various other types of devices, including a barometer 114, an inertial measurement unit (IMU) 116, a transponder, or the like. Flight control subsystem 102 may also provide control signals (e.g., in the form of pulsing or pulse width modulation signals) to one or more electronic speed controllers (ESCs) 118, which may be configured to control one or more propulsion devices positioned on the UAV. Flight control subsystem 102 configured in this manner may therefore control the movement of the UAV by controlling one or more electronic speed controllers 118.

Flight control subsystem 102 may also communicate with a vision subsystem 104 configured to detect and visualize (e.g., using computer vision) objects surrounding the UAV. Flight control subsystem 102 may receive information from vision subsystem 104 and utilize the information to determine a flight path (or make adjustments to an existing flight path). For example, based on the information received from vision subsystem 104, flight control subsystem 102 may decide whether to stay on an existing flight path, change the flight path to track an object recognized by vision subsystem 104, or change the flight path (e.g., override a command received from an operator) to avoid an obstacle detected by vision subsystem 104.

It is contemplated that vision subsystem 104 may utilize various types of instrument and/or techniques to detect objects surrounding the UAV. For instance, in some embodiments, vision subsystem 104 may communicate with an ultrasonic module 120 configured to detect objects surrounding the UAV and measure the distances between the UAV and the detected objects. Vision subsystem 104 may communicate with other types of sensors as well, including time of flight (TOF) sensors 122, radars (e.g., including millimeter wave radars), sonars, lidars, barometers, or the like.

Vision subsystem 104 may also communicate with an imaging subsystem 106. Imaging subsystem 106 may be configured to obtained images or video footages using one or more imaging devices (e.g., cameras) 124. Vision subsystem 104 may utilize the images or video footages to generate a visual representation of the environment surrounding the UAV. It is contemplated that such a visual representation may be utilized for various purposes. In some embodiments, for example, vision subsystem 104 may process the visual representation using one or more image recognition or computer vision processes to detect recognizable objects. Vision subsystem 104 may report objects recognized in this manner to flight control subsystem 102 so that flight control subsystem 102 can determine whether or not to adjust the flight path of the UAV. In another example, vision subsystem 104 may provide (e.g., transmit) the visual representation to a remote operator so that the remote operator may be able to visualize the environment surrounding the UAV as if the operator was situated onboard the UAV. In still another example, the visual representation may be recorded in a data storage device located onboard the UAV.

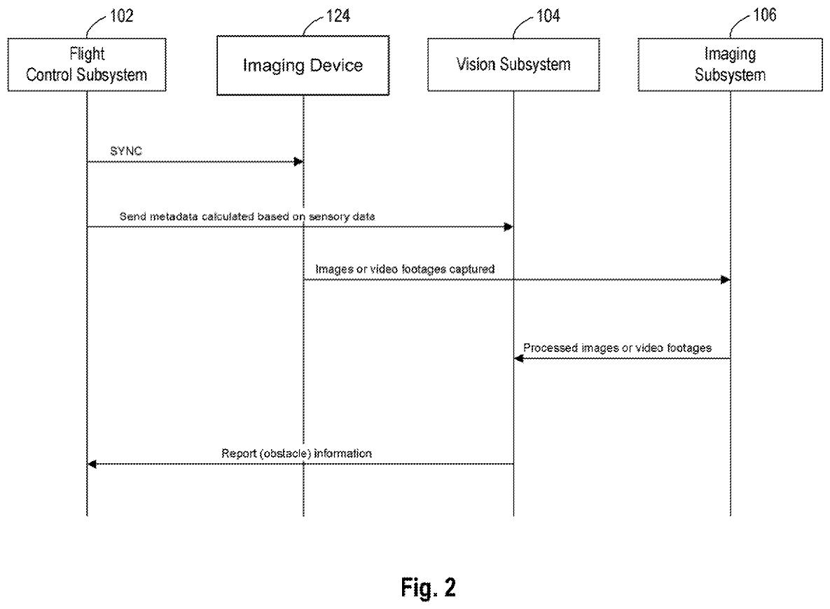

In some embodiments, flight control subsystem 102, vision subsystem 104, imaging subsystem 106, and imaging device 124 may be configured to operate with references to a common time signal. In some embodiments, flight control subsystem 102 may be configured to provide the common time signal in the form of a time synchronization signal (SYNC) and send the time synchronization signal to vision subsystem 104, imaging subsystem 106, and imaging device 124. For example, as depicted in FIG. 2, flight control subsystem 102 may control the timing of exposures (or recordings) of imaging device 124 by sending a time synchronization signal (SYNC) to imaging device 124. Flight control subsystem 102 may also calculate metadata based on various types of sensory data (e.g., location, altitude, heading, temperature, etc.) available to flight control subsystem 102 at the time the SYNC signal was sent to imaging device 124. Flight control subsystem 102 may timestamp the metadata. Other subsystems, such as vision subsystem 104, may recognize the timestamp of the metadata and associate the metadata with the images or video footages captured at the same time. In this manner, vision subsystem 104 may determine precisely what sensory data was reporting at the time the images or video footages were captured.

In some embodiments, the images or video footages captured by imaging device 124 may be in a data format that requires further processing (e.g., data obtained directly from an image sensor may need to be converted to a displayable format). In such embodiments, the images or video footages captured by imaging device 124 may be provided to imaging subsystem 106 for additional processing (e.g., filtering, resizing, downscaling, noise reduction, sharpening, etc.) before being provided to vision subsystem 104. Alternatively or additionally, imaging device 124 or vision subsystem 104 may include one or more processors capable of providing image processing, in which case the images or video footages captured by imaging device 124 may be provided to vision subsystem 104 directly.

Vision subsystem 104 may utilize the images or video footages to detect objects surrounding the UAV and report information regarding the detected objects back to flight control subsystem 102. Vision subsystem 104 may timestamp the report using the same timestamp originally used for the metadata. In this manner, flight control subsystem 102 may be able to determine precisely what the environment surrounding the UAV looks like at a given time so that flight control subsystem 102 can make informed decisions regarding flight path adjustments (e.g., performing obstacle avoidance) if needed. Flight control subsystem 102 may also cross-reference location data received from other devices (e.g., positioning system 112) against image data received from vision subsystem 104 based on timestamps, allowing flight control subsystem 102 to determine precisely what the environment surrounding the UAV looks like at a given location so that flight control subsystem 102 can make informed decisions regarding flight path adjustments if needed.

In some embodiments, one or more imaging devices (e.g., cameras) 124 may be mounted on a gimbal 126. Gimbal 126 may be configured to provide stabilization as well as rotatable support for the imaging device(s) 124 mounted thereon. As shown in FIG. 1, operations of gimbal 126 may be controlled through a gimbal control subsystem 108, which may be in communication with other subsystems (e.g., flight control subsystem 102 and/or imaging subsystem 106) of control system 100. Gimbal control subsystem 108 may, for example, control gimbal 126 to rotate about a vertical axis at a particular rotational speed to allow imaging subsystem 106 to acquire a 360° panoramic view of the environment surrounding the UAV. In another example, if flight control subsystem 102 receives a command (e.g., from an operator) to acquire images or video footages of a particular location, flight control subsystem 102 may instruct gimbal control subsystem 108 to rotate gimbal 126 so that imaging device 124 mounted on gimbal 126 can be pointed toward that particular location. It is to be understood that the examples presented above are merely exemplary and are not meant to be limiting. It is contemplated that gimbal 126 may be configured to respond to various other types of requests without departing from the spirit and scope of the present disclosure.

In some embodiments, the aforementioned flight control subsystem 102, vision subsystem 104, imaging subsystem 106, and gimbal control subsystem 108 may be packaged together to form blocks (or cores) of a single integrated controller. In some embodiments, the integrated controller may be implemented as a system-on-chip (SOC) controller, which may include a single integrated circuit that integrates all components of flight control subsystem 102, vision subsystem 104, imaging subsystem 106, and gimbal control subsystem 108. In some embodiments, the integrated controller may include more than one integrated circuit enclosed in a single package. It is to be understood that while the descriptions below may reference a system-on-chip controller, such references are provided for illustrative purposes and are not meant to be limiting. It is contemplated that integrated controllers configured in accordance with embodiments of the present disclosure may be configured in other manners without departing from the spirit and scope of the present disclosure.

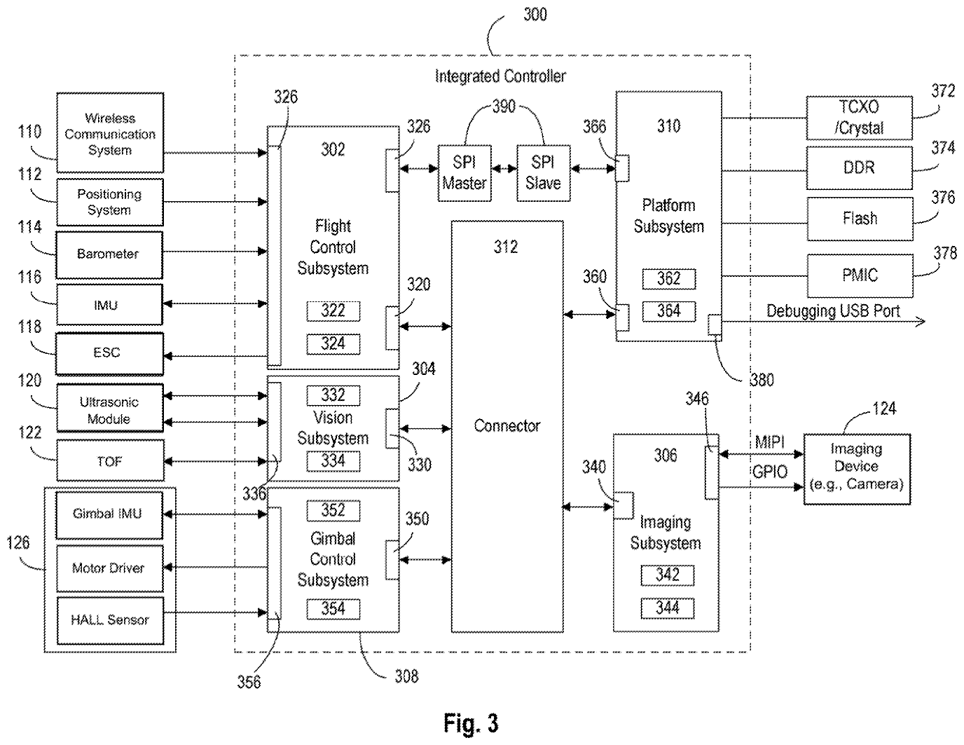

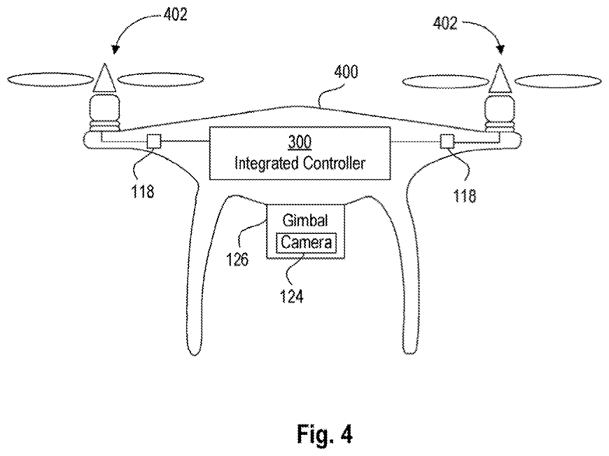

Referring now generally to FIGS. 3 and 4. FIG. 3 shows an exemplary system-on-chip controller 300 configured in accordance with embodiments of the present disclosure. FIG. 4 shows a movable object 400 equipped with system-on-chip controller 300 configured in accordance with embodiments of the present disclosure. It is to be understood that while moveable object 400 is depicted as a UAV in FIG. 4, such a depiction is merely exemplary and is not meant to be limiting. It is contemplated that controller 300 may be utilized to control various other types of moveable objects.

As shown in FIG. 3, controller 300 may include a flight control subsystem block (may also be referred to generally as a movement control subsystem block) 302. Controller 300 may also include a vision subsystem block 304, an imaging subsystem block 306, a gimbal control subsystem block 308, a platform subsystem block 310, and a connector 312 connecting the aforementioned blocks 302-310. In some embodiments, connector 312 may include a bus. The bus may be configured to support connections compatible with advanced microcontroller bus architecture (AMBA), open core protocol (OCP) connector, or various other types of standard or non-standard (customized) connectors. Alternatively or additionally, connector 312 may be configured to support crossbar switching, networking, or other types of connection mechanisms that can facilitate communications between any two blocks connected to connector 312. For instance, in some embodiments, connector 312 may be implemented as a built-in network, which may be formed using standard digital connections and logic gates. It is noted that implementing such a built-in network may help reduce the size, cost, and complexity associated with conventional implementations (which typically require complicated interconnections between multiple microcontrollers or chips).

It is contemplated that flight control subsystem block 302, vision subsystem block 304, imaging subsystem block 306, gimbal control subsystem block 308, and platform subsystem block 310 may connect to connector 312 through their corresponding data ports 320, 330, 340, 350, and 360, respectively. In some embodiments, data ports 320, 330, 340, 350, and 360 may be configured to support connections compatible with AMBA or OCP connector. Alternatively or additionally, data ports 320, 330, 340, 350, and 360 may also be configured to support other types of standard or non-standard (customized) connectors without departing from the spirit and scope of the present disclosure.

In some embodiments, connector 312 may be configured to implement priority arbitration and/or quality of service (QoS) policies. For example, if connector 312 is implemented as a built-in network, connector 312 may be configured to provide QoS policy implementations similar to that utilized in computer networking (or other packet-switched telecommunication networks) to ensure smooth operations of the various blocks connected to connector 312 and to prevent starvation. In some embodiments, recognizing the critical nature of flight control subsystem block 302 to the operation of UAV 400, connector 312 may implement a QoS policy that assigns a higher priority to flight control subsystem block 302 (e.g., compared to other subsystem blocks 304-308) to guarantee a certain level of performance (e.g., data flow) of flight control subsystem block 302.

Alternatively or additionally, one or more dedicated connectors 390 (connectors that are separate from connector 312) may be utilized to provide additional bandwidth to flight control subsystem block 302 if needed. In some embodiments, a connector internal to controller 300 (e.g., an on-chip bus) may be utilized as a dedicated connector 390. Alternatively, controller 300 may be configured to allow a connector external to controller 300 to serve as a dedicated connector 390. It is to be understood that providing a dedicated connector 390 may help reduce the impact of other subsystem blocks on flight control subsystem block 302. Providing dedicated bus 390 may also prevent deadlocks from occurring in controller 300. Deadlocks may occur, for example, when a subsystem block (e.g., vision subsystem block 304) experiences an abnormal behavior (e.g., if vision subsystem block 304 fails to receive an expected handshake or a release signal) and enters a waiting state. If another subsystem block (e.g., flight control subsystem block 302) needs to access vision subsystem block 304, flight control subsystem block 302 may be forced into a waiting state as well. If these subsystem blocks are unable to change their state indefinitely, they are deadlocked, and flight control subsystem block 302 may cease to function properly. It is therefore important to prevent deadlocks from happening to the subsystem blocks contained in controller 300, especially flight control subsystem block 302.

In some embodiments, a dedicated connector 390 may be provided to facilitate communications between one subsystem block (e.g., flight control subsystem block 302) and another subsystem block (e.g., platform subsystem block 310, as shown in FIG. 3). In some embodiments, dedicated connector 390 may include a serial peripheral interface (SPI) bus 390. In some embodiments, the SPI bus 390 may be internalized so that it is fully integrated into controller 300. It is contemplate that internalizing dedicated SPI bus 390 in this manner allows controller 300 to take the advantages (e.g., robustness and reliability) provided by SPI and utilize these advantages for internal communications. In some embodiments, flight control subsystem block 302 may include at least one dedicated internal data port 326 configured to connect flight control subsystem block 302 to dedicated SPI bus 390. Similarly, the other subsystem block (e.g., platform subsystem block 310) may also include at least one dedicated internal data port 366 configured to connect platform subsystem block 310 to dedicated SPI bus 390.

It is to be understood that while FIG. 3 shows the flight control subsystem block 302 being connected to the master of dedicated SPI bus 390, such a depiction is merely presented for illustrative purposes and is not meant to be limiting. It is contemplated that the other subsystem block (e.g., platform subsystem block 310) may be connected to the master instead. It is also contemplated that more than one dedicated SPI bus 390 may be utilized to facilitate communications between flight control subsystem block 302 and other subsystem blocks as well without departing from the spirit and scope of the present disclosure. It is to be understood that while specific implementations may vary, the purpose of using dedicated SPI bus 390 is to keep any failures that may occur on dedicated SPI bus 390 from affecting connector 312. In this manner, if communication between the SPI master and the SPI slave fails, the failure can be contained within dedicated SPI bus 390, which can be reset without affecting other part of controller 300, such as connector 312. It is therefore contemplated that implementing dedicated SPI bus 390 in this manner may improve the robustness of communications between flight control subsystem block 302 and other subsystem blocks (e.g., compared to only relying on connector 312 or using AMBA High-performance Bus (AHB) or Advanced Extensible Interface (AXI) bus). Improving the robustness in this manner may also help prevent potential deadlocks from occurring.

It is to be understood that the reference to SPI in the example above is merely exemplary and is not meant to be limiting. In some embodiments, dedicated connector 390 may include other types of connector (e.g., I2C, universal asynchronous receiver-transmitter (UART), or the like) without departing from the spirit and scope of the present disclosure.

As shown in FIG. 3, flight control subsystem block 302 may also include one or more internal data ports 320 configured to connect flight control block 302 to connector 312. Flight control subsystem block 302 may also include a processor 322. Processor 322 may include one or more dedicated processing units, application-specific integrated circuits (ASICs), field-programmable gate arrays (FPGAs), or various other types of processors or processing units coupled with at least one non-transitory processor-readable memory 324 configured for storing processor-executable code. When the processor-executable code is executed by processor 322, processor 322 may carry out instructions to perform functions associated with flight control subsystem 102 described above. For instance, flight control subsystem block 302 may include one or more external data ports 326 configured to facilitate communications between flight control subsystem block 302 and one or more electronic speed controllers (ESCs) 118. ESCs 118 are in turn connected to one or more propulsion devices 402 positioned on UAV 400 (FIG. 4). Flight control subsystem block 302 so configured may therefore control the movement of UAV 400 by controlling ESCs 118.

Flight control subsystem block 302 may also be configured to communicate with other devices located onboard UAV 400 through data port 326. Such devices may include a wireless system 110, a GNSS 112, a barometer 114, an IMU 116, a transponder, or the like. In some embodiments, flight control subsystem block 302 may utilize a universal asynchronous receiver-transmitter (UART) microchip to control the communication interface between flight control subsystem block 302 and wireless system 110 as well as the communication interface between flight control subsystem block 302 and GNSS 112. In some embodiments, flight control subsystem block 302 may utilize a serial peripheral interface (SPI) bus to facilitate communications with barometer 114 and IMU 116.

Vision subsystem block 304 may include one or more internal data port 330 configured to connect vision subsystem block 304 to connector 312. Vision subsystem block 304 may also include a processor 332. Processor 332 may include one or more dedicated processing units, ASICs, FPGAs, or various other types of processors or processing units coupled with at least one non-transitory processor-readable memory 334 configured for storing processor-executable code. When the processor-executable code is executed by processor 332, processor 332 may carry out instructions to perform functions associated with vision subsystem 104 described above. For instance, vision subsystem block 304 may be configured to process images or video footages obtained to generate a visual representation of the environment surrounding UAV 400.

Vision subsystem block 304 may also include one or more external data ports 336 configured to facilitate communications between vision subsystem block 304 and other devices located onboard the UAV, such as ultrasonic module 120, TOF sensors 122, radars, sonars, lidars, and the like. In some embodiments, vision subsystem block 304 may utilize a serial peripheral interface (SPI) bus and/or a general-purpose input/output (GPIO) interface to facilitate communications with an ultrasonic module 120. In some embodiments, vision subsystem block 304 may utilize a serial computer bus such as I2C or the like to facilitate communications with a TOF sensor 122.

Imaging subsystem block 306 may include one or more internal data ports 340 configured to connect imaging subsystem block 306 to connector 312. Imaging subsystem block 306 may also include a processor 342. Processor 342 may include one or more dedicated processing units, ASICs, FPGAs, or various other types of processors or processing units coupled with at least one non-transitory processor-readable memory 344 configured for storing processor-executable code. When the processor-executable code is executed by processor 342, processor 342 may carry out instructions to perform functions associated with imaging subsystem 106 described above. For instance, imaging subsystem block 306 may include one or more external data ports 346 configured to facilitate communications with one or more imaging devices (e.g., cameras) 124 positioned on UAV 400. In some embodiments, imaging subsystem block 306 may utilize a mobile industry processor interface (MIPI) and/or a general-purpose input/output (GPIO) interface to facilitate communications with one or more imaging devices 124. Imaging subsystem block 306 configured in this manner may be able to control the operations of one or more imaging devices 124 and obtain images or video footages from one or more imaging devices 124.

Gimbal control subsystem block 308 may include one or more internal data ports 350 configured to connect gimbal control subsystem block 308 to connector 312. Gimbal control subsystem block 308 may also include a processor 352. Processor 352 may include one or more dedicated processing units, ASICs, FPGAs, or various other types of processors or processing units coupled with at least one non-transitory processor-readable memory 354 configured for storing processor-executable code. When the processor-executable code is executed by processor 352, processor 352 may carry out instructions to perform functions associated with gimbal control subsystem 108 described above. For instance, gimbal control subsystem 108 may include one or more external data ports 356 configured to facilitate communications with one or more gimbals 126 positioned on UAV 400. In some embodiments, gimbal control subsystem block 308 may utilize a serial peripheral interface (SPI) bus and/or an interface that supports data communication in the form of pulsing or pulse width modulation (PWM) signals to facilitate communications with one or more components of a gimbal 126. Gimbal control subsystem block 308 configured in this manner may be able to effectively control the operations of gimbal 126 as previously described.

Platform subsystem block 310 may include one or more internal data ports 360 configured to connect platform subsystem block 310 to connector 312. Platform subsystem block 310 may also include a processor 362. Processor 362 may include one or more dedicated processing units, ASICs, FPGAs, or various other types of processors or processing units coupled with at least one non-transitory processor-readable memory 364 configured for storing processor-executable code. When the processor-executable code is executed by processor 362, processor 362 may carry out instructions to provide timing, power management, task delegation/management, and resource (e.g., bandwidth, data storage, data port) management to the other blocks 302-308 contained in controller 300.

In some embodiments, for example, platform subsystem block 310 may include a timing unit (timer) 372. Timing unit 372 may be implemented as an integrated component of platform subsystem block 310. Alternatively, timing unit 372 may be implemented as a device separate from, but communicatively connected to, the circuitry of platform subsystem block 310. Timing unit 372 may include a device capable of generating time references (e.g., oscillating signals). Such devices may include, but are not limited to, resistor-capacitor (RC) oscillators, temperature compensated crystal oscillators (TCXO), crystals, quartz, or the like. It is contemplated that RC oscillators (and other types of oscillators implemented using semiconductor materials) may be implemented as integrated components of platform subsystem block 310 (or controller 300 in general). Oscillators implemented using other types of materials (e.g., TCXO, crystals, quartz and the like) may be implemented as external components communicatively connected to the circuitry of platform subsystem block 310.

It is contemplated that timing unit 372 configured in this manner may serve as a universal reference of time to all blocks 302-310 contained in controller 300. In some embodiments, timing unit 372 may be configured to provide the universal reference of time at a fixed frequency (e.g., 38.4 MHz). If some of the blocks contained in controller 300 require timing signals at different frequencies, platform subsystem block 310 may utilize one or more phase-locked loops (PLLs) to generate timing signals having desired frequencies for those blocks. For example, if flight control subsystem block 302 requires a timing signal at 200 MHz and vision subsystem block 304 requires a different timing signal at 500 MHz, a first PLL may be utilized to generate a timing signal for flight control subsystem block 302 at 200 MHz and a second PLL may be utilized to generate a timing signal for vision subsystem block 304 at 500 MHz, where both PLLs are configured to operate based on the universal reference of time provided by timing unit 372. In this manner, timing unit 372 may be able to provide different timing signals to different subsystems. It is to be understood that while specific implementations of the PLLs may vary, the underlining reference of time is still universally shared among all blocks contained in controller 300.

It is to be understood that the reference to a timing unit configured to generate a time reference at 38.4 MHz in the example above is merely exemplary and is not meant to be limiting. It is also to be understood that the PLLs referenced above may be implemented as integrated components of timing unit 372, or as components separate from, but communicatively connected to, the circuitry of timing unit 372. Furthermore, it is to be understood that not all PLLs are required to be engaged at all times. For example, if a subsystem block (e.g., gimbal control subsystem block 308) is not being used at a given moment, its corresponding PLL may be disengaged temporarily to reduce power consumption. Alternatively or additionally, it is contemplated that one or more PLLs included in controller 300 may be configured to operate at lower frequencies to help reduce power consumption.

In some embodiments, platform subsystem block 310 may include a data storage device 374. Data storage device 374 may be implemented as an integrated component of platform subsystem block 310. Alternatively, data storage device 374 may be implemented as a device separate from, but communicatively connected to, the circuitry of platform subsystem block 310. Data storage device 374 may include, for example, a double data rate (DDR) random-access memory. Data storage device 374 may also include other types of memories without departing from the spirit and scope of the present disclosure.

It is contemplated that data storage device 374 configured in this manner may serve as a shared data storage device accessible to multiple blocks contained in controller 300. For example, in some embodiments, various blocks contained in controller 300 may be configured to access data storage device 374 through platform subsystem block 310. Alternatively and/or additionally, in some embodiments, data storage device 374 may be configured to support multiple data ports, allowing different blocks contained in controller 300 to access data storage device 374 using different (unique) data ports made available to them.

It is to be understood that the DDR random-access memory referenced in the example above is merely exemplary and is not meant to be limiting. It is contemplated that other types of data storage devices may be utilized without departing from the spirit and scope of the present disclosure. For instance, in some embodiments, platform subsystem block 310 may include a data storage device 376, which may be implemented as a non-volatile storage such as flash storage or the like. It is contemplated that data storage device 376 may be configured as a shared data storage device in similar manners as described above.

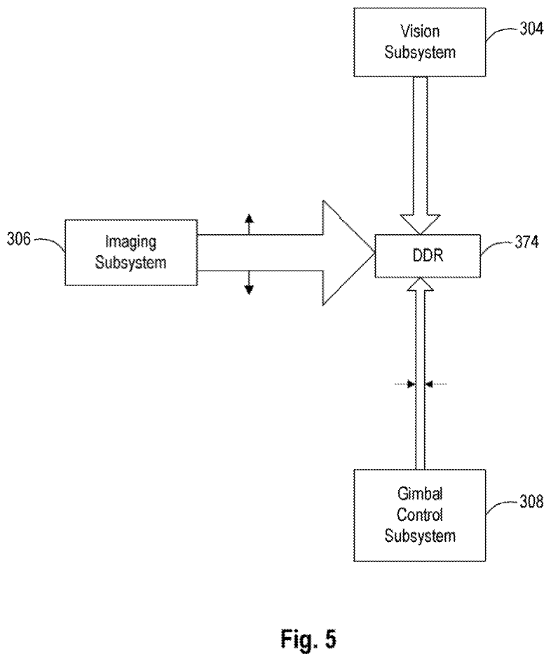

In some embodiments, platform subsystem block 310 may also include a bandwidth management unit (bandwidth manager or bandwidth management circuit) (not shown). The bandwidth management unit may be implemented as an integrated component of platform subsystem block 310. Alternatively, the bandwidth management unit may be implemented as a device separate from, but communicatively connected to, the circuitry of platform subsystem block 310. In some embodiments, the bandwidth management unit may be configured to manage bandwidth consumptions with respect to access to shared resources (e.g., data storage devices 374 or 376). For instance, the bandwidth management unit may assign a fixed bandwidth to each of vision subsystem block 304, imaging subsystem block 306, and gimbal control subsystem block 308. Alternatively, as shown in FIG. 5, the bandwidth management unit may dynamically adjust bandwidth allocations to vision subsystem block 304, imaging subsystem block 306, and gimbal control subsystem block 308 based on their processing needs. For example, the bandwidth management unit may assign a higher priority to imaging subsystem block 306 and allocate more bandwidth to imaging subsystem block 306 when imaging subsystem block 306 is actively processing images or video footages. The bandwidth management unit may reduce the bandwidth allocated to one of the subsystem blocks to compensate for the increased allocation to imaging subsystem block 306. In some embodiments, the bandwidth management unit may determine which subsystem block should have its allocated bandwidth reduced based on specific operations performed by the UAV. For instance, if the UAV is being used to film a particular object from a stationary location, the UAV may not need to adjust its camera location and the bandwidth management unit may therefore temporarily reduce the bandwidth allocated to gimbal control subsystem block 308 to compensate for the increased allocation to imaging subsystem block 306.

In some embodiments, the bandwidth management unit may always assign the highest priority to flight control subsystem block 302 because flight control subsystem block 302 is mission critical to the UAV and requires real-time computing. Alternatively or additionally, in some embodiments, flight control subsystem block 302 may be configured to operate utilizing memories 324 located within flight control subsystem block 302 to guarantee response within specified time constraints. In some embodiments, memories 324 may include one or more random-access memories (RAM) configured to provide fast access to processor 322 of flight control subsystem block 302. In some embodiments, flight control subsystem block 302 may not need to access shared memory resources (e.g., data storage devices 374 or 376) at all, and the bandwidth management unit may not need to manage bandwidth allocation with respect to flight control subsystem block 302.

It is contemplated that the bandwidth management unit may also be configured to manage bandwidth consumption of various other types of resources without departing from the spirit and scope of the present disclosure. In some embodiments, the bandwidth management unit may implement quality of service (QoS) policy objectives (e.g., similar to QoS policy implementations utilized in computer networking and other packet-switched telecommunication networks). For instance, QoS profiles (e.g., bandwidth limits) may be established for some of the blocks contained in controller 300. The bandwidth management unit may utilize the QoS profiles to manage bandwidth consumptions on connector 312 and/or bandwidth consumptions with respect to access to shared resources (e.g., data storage devices 374 or 376) as previously described. The bandwidth management unit implemented in this manner may ensure smooth operations of the various blocks contained in controller 300 and prevent starvation.

In some embodiments, platform subsystem block 310 may further include a power management integrated circuit (PMIC) 378. PMIC 378 may be implemented as an integrated component of platform subsystem block 310. Alternatively, PMIC 378 may be implemented as a device separate from, but communicatively connected to, the circuitry of platform subsystem block 310. In some embodiments, PMIC 378 may be configured to supply power to the various blocks contained in controller 300. In some embodiments, PMIC 378 may be further configured to manage power consumption of the various blocks contained in controller 300. It is to be understood that while PMIC 378 may be configured to provide both power supply and power management, such a configuration is merely exemplary and is not meant to be limiting. It is contemplated that power supply and power management may be implemented as separate components (e.g., circuits) or as an integrated component without departing from the spirit and scope of the present disclosure.

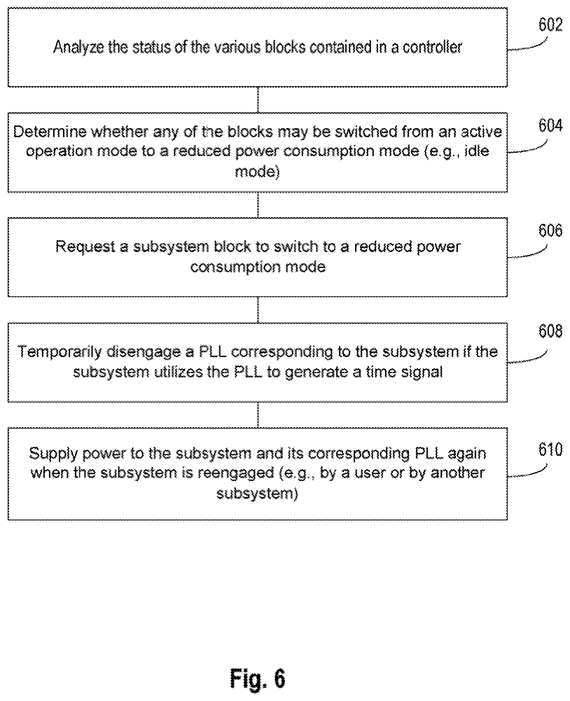

In some embodiments, as shown in FIG. 6, PMIC 378 (or a separate power management circuit) may be configured to analyze the status of the various blocks contained in controller 300 in a step 602 and determine whether any of the blocks may be switched from an active operation mode to a reduced power consumption mode (e.g., idle mode) in a step 604. If a subsystem block is not being used at the moment, PMIC 378 may request that subsystem block to switch to a reduced power consumption mode in a step 606. For example, if gimbal 126 does not need to be adjusted during a particular operation, PMIC 378 may put gimbal control subsystem block 308 to a standby or an idle mode until gimbal 126 needs to be adjusted again. If gimbal control subsystem block 308 utilizes a clock or a PLL to generate its time signal (as previously described), PMIC 378 may also temporarily disengage or turn off the clock or the PLL of gimbal control subsystem block 308 in a step 608 to further reduce power consumption. PMIC 378 may supply power to the subsystem and its corresponding clock or PLL again when the subsystem is reengaged (e.g., by a user or by another subsystem) in a step 610. In some embodiments, PMIC 378 (or a separate power management circuit) may also be configured to manage power consumption by controlling (e.g., decreasing or increasing) the frequencies of time signals provided to the various blocks contained in controller 300. For example, PMIC 378 may decrease the frequency of a time signal provided to a particular subsystem block to reduce power consumption of that subsystem block. It is contemplated that having the ability to manage power consumption in this manner may be appreciated in various situations, including situations where power supply is limited by design (e.g., a small, less expensive, or low-end UAV may be designed to have a limited power supply).

In some embodiments, platform subsystem block 310 may provide a shared data port 380 (e.g., a Universal Serial Bus (USB) port or a Joint Test Action Group (JTAG) port) accessible to the various blocks contained in controller 300. It is contemplated that such a shared data port 380 may be utilized to download firmware updates for the various blocks contained in controller 300. It is contemplated that shared data port 380 may also serve as a universal debug port. If a system engineer needs to debug flight control subsystem block 302, for example, the system engineer may connect a debug tool (e.g., a computer) to shared data port 380 and request platform subsystem block 310 to establish a connection between the debug tool and flight control subsystem block 302. The system engineer may debug blocks 304-308 in similar manners. It is noted that providing shared data port 380 in this manner allows flight control subsystem block 302, vision subsystem block 304, imaging subsystem block 306, and gimbal control subsystem block 308 to eliminate their own debug ports, effectively reducing the size, complexity, and cost associated with having to implement these debug ports.

It is contemplated that shared data port 380 may also serve as a universal data port for the various blocks contained in controller 300. For example, imaging subsystem block 306 may use data port 380 to establish a connection with wireless communication system (e.g., a Wi-Fi device) 110 and utilize the wireless communication system 110 to transmit images or video footages. In another example, platform subsystem block 310 may use data port 380 to establish a connection with a computer, which may be utilized (e.g., by a system engineer) to test or configure operations of platform subsystem block 310 (or controller 300 in general). It is contemplated that flight control subsystem block 302, vision subsystem block 304, imaging subsystem block 306, and gimbal control subsystem block 308 may also use data port 380 as needed, and in some embodiments, platform subsystem block 310 may be configured to manage utilization of data port 380 as a shared resource. In some embodiments, for instance, platform subsystem block 310 may be configured to grant the various blocks contained in controller 300 equal access (e.g., equal time division) to data port 380. Alternatively, in some embodiments, platform subsystem block 310 may be configured to dynamically adjust access granted to the various blocks contained in controller 300 based on their processing needs. In some embodiments, access priorities may be assigned to the various blocks contained in controller 300. It is noted, however, that such priority assignments may be optional.

In some embodiments, platform subsystem block 310 may be further configured to provide processing assistance to one or more blocks contained in controller 300. For example, suppose wireless communication system 110 received remote control instructions from an operator that include instructions related to adjustments of the flight path of UAV 400, the position of gimbal 126, and the operation of camera 124. Suppose also that wireless communication system 110 is configured to forward the received instructions to flight control subsystem block 302. Flight control subsystem block 302 may process the received instructions and delegate instructions that are deemed to be non-flight-related to platform subsystem block 310 for further processing. Flight control subsystem block 302 may determine whether or not a given instruction is flight-related based on the format of the instruction (e.g., the instruction may have a data field indicating whether it is intended for flight control or not). Alternatively or additionally, flight control subsystem block 302 may determine whether or not a given instruction is flight-related based on the subsystem the instruction is directed to control. For instance, if the instruction is directed to control a propeller, the instruction can be deemed to be flight-related. If the instruction is directed to control a camera exposure, the instruction may be deemed to be non-flight-related. It is to be understood that flight control subsystem block 302 may utilize other techniques to determine whether or not a given instruction is flight-related without departing from the spirit and scope of the present disclosure.

Platform subsystem block 310, upon receiving the delegated instructions, may process the delegated instructions and communicate with responsible subsystem blocks to handle the delegated instructions accordingly. Using the example illustrated above, platform subsystem block 310 may communicate with gimbal control subsystem block 308 to adjust the position of gimbal 126, and upon receiving confirmation that gimbal 126 is in position, communicate with imaging subsystem block 306 to control the operation of camera 124 (e.g., setting camera parameters and control the timing of exposures as instructed).

It is to be understood that the example illustrated above is not meant to be limiting. It is contemplated, for example, that wireless communication system 110 may forward all received instructions to platform subsystem block 310 and let platform subsystem block 310 determine which instructions (if any) are non-flight-related or flight-related, then distribute the flight-related instructions to flight control subsystem block 302 and the non-flight-related instructions to other subsystem blocks. In another example, wireless communication system 110 may be configured to send the instructions to both flight control subsystem block 302 and platform subsystem block 310. In this manner, flight control subsystem block 302 may process the received instructions and discard instructions that are deemed to be non-flight-related. Platform subsystem block 310, on the other hand, may process the received instructions, identify the non-flight-related instructions, and process the identified instructions accordingly.

As will be appreciated from the above, by packaging flight control subsystem block 302, vision subsystem block 304, imaging subsystem block 306, and gimbal control subsystem block 308 together to form a single system-on-chip controller 300, the need for large, complex, and expensive interconnections (that would otherwise be required if the blocks were implemented as separate microcontrollers/chips) can be alleviated. Utilizing a single system-on-chip controller 300 also reduces the physical size, weight, and power consumption. For instance, in some embodiments, a controller 300 configured in accordance with embodiments of the present disclosure may have a physical size ranging between approximately 10 mm and approximately 18 mm in width, between approximately 10 mm and approximately 18 mm in length, and between approximately 1 mm and approximately 2 mm in depth/height. In some embodiments, power consumption of controller 300 may be designed to be between approximately 0.5 and approximately 15 watt. Furthermore, in some embodiments, a controller 300 configured in accordance with embodiments of the present disclosure may utilize a clock having a frequency ranging between approximately 100 MHz and approximately 3 GHz. In some embodiments, the number of cores included in a controller 300 configured in accordance with embodiments of the present disclosure may range between 1 and 16.

It is contemplated that controllers configured as described above may be suitable for moveable objects having limited space and limited power supply (e.g., UAVs). It is to be understood, however, that the specific parameters presented above are exemplary and are not meant to be limiting. It is contemplated that the physical size, weight, and power consumption of a particular controller 300 may differ based on particular applications an UAV is configured to perform.

Furthermore, a single system-on-chip controller 300 permits resource sharing that can further reduce the size, cost, and complexity. As mentioned previously, timing unit 372, data storage devices 374 and 376, power management integrated circuit 378, as well as data port 380 can all be shared amongst the various blocks contained in controller 300.

It is to be understood that the disclosed embodiments are not necessarily limited in their application to the details of construction and the arrangement of the components set forth in the following description and/or illustrated in the drawings and/or the examples. The disclosed embodiments are capable of variations, or of being practiced or carried out in various ways.

It will be apparent to those skilled in the art that various modifications and variations can be made to the disclosed devices and systems. Other embodiments will be apparent to those skilled in the art from consideration of the specification and practice of the disclosed devices and systems. It is intended that the specification and examples be considered as exemplary only, with a true scope being indicated by the following claims and their equivalents.

What is claimed is:

1. An integrated controller for controlling a movable object, comprising:
a connector;
a movement control subsystem communicatively coupled to the connector and configured to control movement of the movable object;
a vision subsystem communicatively coupled to the connector and configured to provide visualization of an operating environment surrounding the movable object; and
a platform subsystem communicatively coupled to the connector and configured to provide timing and power management to the movement control subsystem and the vision subsystem.

2. The controller of claim 1, further comprising:
a gimbal control subsystem communicatively coupled to the connector and configured to control operation of a gimbal positioned on the movable object; and
an imaging subsystem communicatively coupled to the connector and configured to control operation of an imaging device mounted on the gimbal,
wherein the vision subsystem is configured to provide the visualization at least partially based on data obtained by the imaging device, and wherein the platform subsystem is further configured to provide timing and power management to the gimbal control subsystem and the imaging subsystem.

3. The controller of claim 2, wherein the platform subsystem further comprises:
a timer configured to provide a universal timing reference to the movement control subsystem, the gimbal control subsystem, the imaging subsystem, and the vision subsystem.

4. The controller of claim 3, wherein the timer is configured to provide one or more different timing signals in addition to the universal timing reference.

5. The controller of claim 2, further comprising a data storage device accessible to at least one of the movement control subsystem, the gimbal control subsystem, the imaging subsystem, the vision subsystem, or the platform subsystem.

6. The controller of claim 5, where in the data storage device comprises a double data rate (DDR) random-access memory.

7. The controller of claim 5, wherein the data storage device comprises a plurality of data ports, and wherein each of the movement control subsystem, the vision subsystem, the gimbal control subsystem, the imaging subsystem, and the platform subsystem is communicatively coupled to the data storage device via a unique data port.

8. The controller of claim 2, wherein the platform subsystem further comprises a data port configured as a universal debug port to the movement control subsystem, the gimbal control subsystem, the imaging subsystem, and the vision subsystem.

9. The controller of claim 2, wherein the platform subsystem further comprises a power controller configured to manage power consumption of the movement control subsystem, the gimbal control subsystem, the imaging subsystem, and the vision subsystem.

10. The controller of claim 2, wherein the platform subsystem further comprises a bandwidth manager configured to manage bandwidth consumption of the movement control subsystem, the gimbal control subsystem, the imaging subsystem, and the vision subsystem.

11. The controller of claim 1, further comprising:
a dedicated connector configured to connect the movement control subsystem and the platform subsystem.

12. The controller of claim 11, wherein the movement control subsystem further comprises a first dedicated internal data port configured to connect the movement control subsystem to a first end of the dedicated connector, and the platform subsystem further comprises a second dedicated internal data port configured to connect the platform subsystem to a second end of the dedicated connector.

13. A moveable object, comprising:
one or more propulsion devices; and
an integrated controller in communication with the one or more propulsion devices and configured to control the moveable object, the controller comprising:
a connector;
a movement control subsystem communicatively coupled to the connector and configured to control movement of the movable object;
a vision subsystem communicatively coupled to the connector and configured to provide visualization of an operating environment surrounding the movable object; and
a platform subsystem communicatively coupled to the connector and configured to provide timing and power management to the movement control subsystem and the vision subsystem.

14. The movable object of claim 13, wherein the controller further comprises:
a gimbal control subsystem communicatively coupled to the connector and configured to control operation of a gimbal positioned on the movable object; and
an imaging subsystem communicatively coupled to the connector and configured to control operation of an imaging device mounted on the gimbal,
wherein the vision subsystem is configured to provide the visualization at least partially based on data obtained by the imaging device, and wherein the platform subsystem is further configured to provide timing and power management to the gimbal control subsystem and the imaging subsystem.

15. The movable object of claim 13, wherein the movable object is an unmanned aerial vehicle (UAV).

16. The movable object of claim 13, wherein the platform subsystem further comprises:
a timer configured to provide a universal timing reference to the movement control subsystem and the vision subsystem.

17. The movable object of claim 13, wherein the controller further comprises a data storage device accessible to at least one of the movement control subsystem, the vision subsystem, or the platform subsystem.

18. The movable object of claim 13, wherein the platform subsystem further comprises a data port configured as a universal debug port to the movement control subsystem and the vision subsystem.

19. The movable object of claim 13, wherein the platform subsystem further comprises a power controller configured to manage power consumption of the movement control subsystem and the vision subsystem.

20. The movable object of claim 13, wherein the platform subsystem further comprises a bandwidth manager configured to manage bandwidth consumption of the movement control subsystem and the vision subsystem.
